(19) United States
(12) Patent Application Publication
(10) Pub. No.: US 2024/0227068 A1
(43) Pub. Date: Jul. 11, 2024

(54) DETECTION DEVICES FOR LASER SPOT WELDING MICRO-WELD SPOT QUALITY BASED ON LASER

(71) Applicant: NANJING UNIVERSITY, Nanjing (CN)

(72) Inventors: Minghui LU, Nanjing (CN); Lei DING, Nanjing (CN); Xuejun YAN, Nanjing (CN); Qiangbing LU, Nanjing (CN); Xiaodong XU, Nanjing (CN); Yanfeng CHEN, Nanjing (CN)

(73) Assignee: NANJING UNIVERSITY, Nanjing (CN)

(21) Appl. No.: 18/586,381

(22) Filed: Feb. 23, 2024

Related U.S. Application Data
(63) Continuation of application No. PCT/CN2022/105335, filed on Jul. 13, 2022.

(30) Foreign Application Priority Data
Aug. 23, 2021 (CN) 202110971229.X

(51) Int. Cl. B23K 26/03; B23K 26/06; B23K 26/0622; B23K 26/067; B23K 26/22; B23K 31/12

(52) U.S. Cl. CPC B23K 26/032; B23K 26/0624; B23K 26/0643; B23K 26/067; B23K 26/22; B23K 31/125

(57) ABSTRACT

Embodiments of the present disclosure provide a detection device for laser spot welding micro-weld spot quality based on laser ultrasound. The device includes: a nanosecond pulsed laser configured to emit a laser; the polarizing beam splitter configured to perform a laser beam splitting, wherein a laser beam after performing the laser beam splitting by the polarizing beam splitter enter an energy detector and a beam splitter mirror, respectively; the beam splitter mirror configured to perform the laser beam splitting on the laser entering the beam splitter mirror, wherein a laser beam after performing the laser beam splitting enter a photodetector and a light reflecting mirror, respectively; an aperture configured for the laser beam passing through the light reflecting mirror, the laser passing through a scanning galvanometer to reach a multi-axis displacement platform; the multi-axis displacement platform configured to place and/or move a sample.

### CROSS-REFERENCE

This application is a Continuation of International Application No. PCT/CN2022/105335, filed on Jul. 13, 2022, which claims priority to Chinese Patent Application No. 202110971229.X, filed on Aug. 23, 2021, the contents of which are hereby incorporated by reference.

### TECHNICAL FIELD

The present disclosure relates to a field of welding spot quality detection, and in particular relates to a detection device for laser spot welding micro-weld spot quality based on laser.

### BACKGROUND

Laser spot welding (LSW) is a highly efficient and precise welding process using a high energy density laser beam as a heat source, and is one of the most important aspects of laser material processing technology applications. The LSW is widely used in aerospace, automotive industry, nuclear energy, and electronics industry. Compared with traditional welding processes, the LSW has advantages of fast welding speed, high heating and cooling rate, high positioning accuracy, small heat-affected zone, and small structural deformation. As a size of the welding spot is usually on the order of hundreds of micrometers, the LSW is particularly suitable for precision welding of tiny parts. While the LSW has the above advantages, due to the large count of welding spots, the quality of each welding spot may be qualified in order to ensure the safety of devices. Otherwise, if there are defects such as false soldering, leakage of soldering, porosity, inclusions during the welding process, or fatal defects may be caused to the whole life of the welding workpiece.

Currently, two processes are mainly used for the LSW quality detection: a destructive detection and a non-destructive detection. A metallographic detection may observe a morphology of the molten pool accurately. However, the metallographic detection is destructive, the detection efficiency is low, which may not be detected online and may not meet requirements of large-scale industrial production. On the contrary, non-destructive detection technologies are widely used in the quality detection of structural components, especially an ultrasonic process. However, the ultrasonic detection requires an additional layer of coupling fluid between a transducer and a workpiece, which is a contact detection and cannot be applied to harsh environments (e.g., high temperatures, severe radiation, etc.).

Therefore, it is desired to provide a detection device for laser spot welding micro-weld spot quality based on laser ultrasound, which is capable of evaluating the quality of micro laser welding spot in a completely non-contact and non-destructive detection and estimation, and may be applied to high-temperature and extreme environments and the detection of structural members with complex morphology.

### SUMMARY

One aspect of embodiments of the present disclosure may provide a detection device for laser spot welding micro-weld spot quality based on laser ultrasound. The detection device may include a nanosecond pulsed laser configured to emit a laser, wherein the laser passes through a half-wave plate to reach a polarizing beam splitter; the polarizing beam splitter configured to perform a laser beam splitting, wherein a laser beam after performing the laser beam splitting by the polarizing beam splitter enters an energy detector and a beam splitter mirror, respectively, and the energy detector is connected with a processor by a head of the energy detector; the beam splitter mirror configured to perform the laser beam splitting on the laser entering the beam splitter mirror, wherein the laser beam after performing the laser beam splitting enter a photodetector and a light reflecting mirror, respectively, the photodetector is connected with the processor, and the light reflecting mirror is configured to change a direction of the laser beam; an aperture configured for the laser beam passing through the light reflecting mirror, the laser beam passing through a scanning galvanometer to reach a multi-axis displacement platform; the multi-axis displacement platform configured to place and/or move a sample; wherein the multi-axis displacement platform, an optical filter, and a laser Doppler vibrometer are deployed in a same line, and the laser Doppler vibrometer is connected with the processor.

Another aspect of embodiments of the present disclosure may provide a detection method for laser spot welding micro-weld spot quality based on laser ultrasound, wherein the method is executed by a processor. The method may include performing a one-dimensional linear shape scanning and a two-dimensional rectangular shape scanning under a first condition, wherein the first condition includes a laser beam and a probe light on an opposite side of a sample; performing the two-dimensional rectangular shape scanning under a second condition, wherein the second condition includes the laser beam and the probe light on a same side of the sample; controlling a scanning path of the scanning galvanometer by the processor, recording positions of a plurality of excitation points and a position of a detection spot, visualizing an acoustic field of an ultrasonic wave, and obtaining a result of a visualization process; determining an energy density spectrum of transmission; generating a dispersion characteristic curve of a Lamb wave based on a preset algorithm, wherein the preset algorithm includes a two-dimensional Fourier transform, and an expression of the preset algorithm is shown in formula(c):

U(f,k)=∫_{-∞}^{∞}∫_{-∞}^{∞}u(ti,X_{Bi})e^{-j(2πft-kX}^{_{Bi}}⁾dtdX_{Bi} (c)

wherein j represents an imaginary number, f represents a frequency, k represents a wave number, ti represents a moment of scanning to an ith excitation point, X_{Bi} represents a position of the ith excitation point, a range of i includes 1-n, and n represents a count of excitation point, u(ti,X_{Bi}) represents a value of a spatial domain, and U(f,k) represents a value of a frequency domain; generating a speed-frequency curve; determining welding quality of laser spot welding based on the visualization processing result, the dispersion characteristic curve of the Lamb wave, and the speed-frequency curve.

### BRIEF DESCRIPTION OF FIGURES

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating an exemplary structure of a detection device for laser spot welding micro-weld spot quality based on laser ultrasound according to some embodiments of the present disclosure;

FIG. 2 is a schematic diagram illustrating a cross-sectional view of a sample according to some embodiments of the present disclosure;

FIG. 3 is a schematic diagram illustrating a one-dimensional linear shape scanning according to some embodiments of the present disclosure;

FIG. 4 is a schematic diagram illustrating a two-dimensional rectangular shape scanning according to some embodiments of the present disclosure;

FIG. 5 is a flowchart illustrating an exemplary detection process of a detection device for laser spot welding micro-weld spot quality based on laser ultrasound according to some embodiments of the present disclosure;

FIG. 6 is a schematic diagram illustrating an exemplary Lamb wave according to some embodiments of the present disclosure;

FIG. 7 is a schematic diagram illustrating an exemplary visualization ultrasonic field map according to some embodiments of the present disclosure, wherein (a) and (b) are schematic diagrams illustrating 1.2 mm standard welding at different moments, and (c) and (d) are schematic diagrams illustrating a 0.4 mm standard welding and a 0.4 mm false welding at the same moment;

FIG. 8 is a schematic diagram illustrating an exemplary industrial computed tomography (CT) testing result according to some embodiments of the present disclosure; wherein (a) is a schematic diagram illustrating a top view of a 1.2 mm standard welding diagram, (b) is a schematic diagram illustrating a cross-sectional view of a 1.2 mm standard welding diagram, (c) is a schematic diagram illustrating a top view of a 1.2 mm false welding diagram, and (d) is a schematic diagram illustrating a cross-sectional view of a 1.2 mm false welding diagram.

### DETAILED DESCRIPTION

In order to more clearly illustrate the technical solutions of the embodiments of the present disclosure, the accompanying drawings, which are required to be used in the description of the embodiments, are briefly described below. The accompanying drawings do not represent the entirety of the embodiments.

It should be understood that the terms “system,” “device” as used herein, “unit” and/or “module” as used herein is a way to distinguish between different components, elements, parts, sections or assemblies at different levels. The words may be replaced by other expressions if other words accomplish the same purpose.

As shown in the present disclosure and in the claims, unless the context clearly suggests an exception, the words “a,” “an,” and/or “the” do not refer specifically to the singular, but may also include the plural. Generally, the terms “including” and “comprising” suggest only the inclusion of clearly identified steps and elements. In general, the terms “including” and “comprising” only suggest the inclusion of explicitly identified steps and elements that do not constitute an exclusive list, and the method or apparatus may also include other steps or elements.

When describing the operations performed in the embodiments of the present disclosure in step-by-step fashion, the order of the steps is all interchangeable if not otherwise indicated, the steps are omissible, and other steps may be included in the operation.

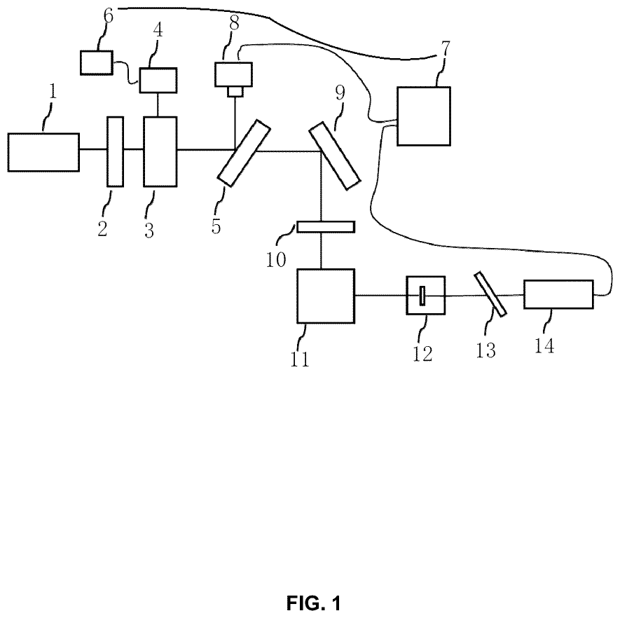

FIG. 1 is a schematic diagram of the structure of a detection device for laser spot welding micro-weld spot quality based on laser ultrasound according to some embodiments of the present disclosure.

In some embodiments, a detection device for laser spot welding micro-weld spot quality based on laser ultrasound may comprise: a nanosecond pulsed laser 1 configured to emit a laser, wherein the laser emitted by the nanosecond pulsed laser 1 may pass through a half-wave plate 2 to reach a polarizing beam splitter 3; the polarizing beam splitter 3 configured to perform a laser beam splitting, wherein a laser beam after performing the laser beam splitting by the polarizing beam splitter 3 may enter an energy detector 4 and a beam splitter mirror 5, respectively; the beam splitter mirror 5 configured to perform the laser beam splitting on the laser entering the beam splitter mirror, wherein the laser beam after performing the laser beam splitting may enter a photodetector 8 and a light reflecting mirror 9, respectively; an aperture 10 configured for the laser beam passing through the light reflecting mirror 9, the laser beam passing through a scanning galvanometer 11 to reach a multi-axis displacement platform 12; the multi-axis displacement platform 12 configured to place and/or move a sample.

In some embodiments, the nanosecond pulsed laser 1 may be configured to emit the laser. In some embodiments, a wavelength range and a pulse width range of the nanosecond pulsed laser may be preset. For example, the wavelength range may include 532-1064 nm and the pulse width range may include 6-12 ns. For example, the wavelength may be 1064 nm and the pulse width may be 8 ns.

In some embodiments, the laser emitted from the nanosecond pulsed laser 1 may pass through the half-wave plate 2 to reach the polarizing beam splitter 3.

The half-wave plate 2 may be used to generate a phase difference equal to π or an odd multiple of π between an ordinary light and an extraordinary light of the incoming laser. The ordinary light refers to a refracted light that follows laws of refraction. The extraordinary light refers to a refracted light that does not follow laws of refraction.

The polarizing beam splitter 3 may be configured to perform the laser beam splitting. In some embodiments, the laser beam after performing the laser beam splitting by the polarizing beam splitter 3 may enter the photodetector 4 and the light reflecting mirror 5, respectively.

The energy detector 4 may be configured to detect a beam energy of the laser. A head 6 of energy detector may be configured to display a numerical value of the beam energy of the laser detected by the energy detector 4. In some embodiments, the energy detector 4 may be connected with the processor 7 via the head 6 of the energy detector according to a preset process. The preset connection process may include a cable connection, a wireless connection, or the like.

The beam splitter mirror 5 may be configured to perform the laser beam splitting on the laser entering the beam splitter mirror. In some embodiments, the laser beam after performing the laser beam splitting by the beam splitter mirror 5 may enter the photodetector 8 and the light reflecting mirror 9, respectively.

The light reflecting mirror 9 may be configured to change a direction of the laser beam. In some embodiments, the laser beam reflected by the light reflecting mirror 9 may pass through the aperture 10 and enter the scanning galvanometer 11.

The photodetector 8 may be configured to convert an optical signal into an electrical signal. In some embodiments, the photodetector 8 may be connected with the processor 7 according to a preset connection process.

The aperture 10 may be configured for the laser beam passing through the light reflecting mirror, the laser beam may pass through a scanning galvanometer to reach a multi-axis displacement platform.

The scanning galvanometer 11 is configured to focus the laser beam as a point source and excite an ultrasonic wave on a surface of the sample according to a preset scanning path. In some embodiments, a maximum resonant frequency of the scanning galvanometer may be 10 kHz.

In some embodiments, the scanning galvanometer 11 may be connected with the processor 7 according to a preset connection process. More descriptions of the preset connection process may be found in the above descriptions of the present disclosure.

In some embodiments, the scanning galvanometer 11 may excite the ultrasonic wave on the surface of the sample based on a scanning parameter. The scanning parameter may include a scanning position and a preset scanning path.

The sample refers to a welding member for testing the detection device for laser spot welding micro-weld spot quality based on laser ultrasound. In some embodiments, the sample may be composed by a variety of forms, for example, the sample may include two pieces of sheet metal welded together. In some embodiments, material of the sample may include stainless steel, aluminum alloy, or the like.

In some embodiments, a plurality of samples with different welding spot characteristics may be used when testing the detection device for laser spot welding micro-weld spot quality based on laser ultrasound. The welding spot characteristics may characterize process parameters of the welding spots on the sample. In some embodiments, the welding spot characteristics may include quality of the welding, a diameter of the welding spot, such as a standard welding or false welding with welding spot characteristics that a diameter is 1.2 mm. The standard welding refers to welding having acceptable quality. The false welding refers to welding with unqualified quality.

The preset scanning path refers to a preset path along which the scanning galvanometer excites the ultrasonic wave on the surface of the sample. In some embodiments, the preset scanning path may include a one-dimensional linear shape scanning and a two-dimensional rectangular shape scanning.

In some embodiments, when the preset scanning path is the one-dimensional linear shape scanning, the laser beam and the probe light are on an opposite side of the sample. The probe light is emitted by a laser Doppler vibrometer.

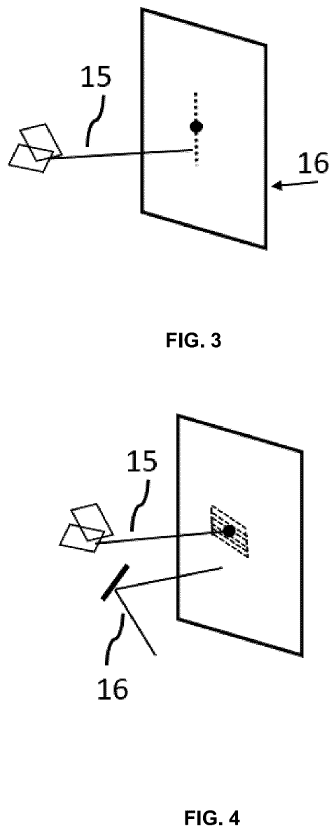

In some embodiments, as shown in FIG. 3, when the preset scanning path is the one-dimensional linear shape scanning and laser beam 15 and a probe light 16 are on the opposite side of the sample, the laser beam 15 and the probe light 16 are located in the same perpendicular direction, the probe light 16 is located below the laser beam 15, and a center of a scanning path of the laser beam 15 is a position of a welding spot. The position of the welding spot is an actual position where the welding spot is located on a side of the sample facing the laser beam.

The center of the scanning path refers to a position of a center point of the preset scanning path. In some embodiments, when the preset scanning path is the one-dimensional linear shape scanning, the center of scanning path is a midpoint of the linear shape.

In some embodiments, the preset scanning path is the two-dimensional rectangular shape scanning, the laser beam and the probe light are on an opposite or same side of the sample.

In some embodiments, when the preset scanning path is the two-dimensional rectangular shape scanning and the laser beam and the probe light are on the opposite side of the sample, the position of the probe light is a backside position of a welding spot, and the center of the scanning path of the laser beam is a position of the welding spot. A backside position of the welding spot is an actual position of the welding spot on a side of the sample that faces the probe light.

In some embodiments, as shown in FIG. 4, when the welding spot path is the two-dimensional rectangular shape scanning and the laser beam 15 and the probe light 16 are on the same side of the sample, the probe light 16 is located directly below the preset scanning path, and the center of the scanning path of the laser beam 15 is the position of the welding point.

In some embodiments, when the preset scanning path is the two-dimensional rectangular shape scanning, the center of the scanning path is a geometric center of the rectangular shape.

The multi-axis displacement platform 12 may be configured to place and/or move the sample. In some embodiments, the multi-axis displacement platform 12, an optical filter 13, and a laser Doppler vibrometer 14 are deployed in a same line.

The laser Doppler vibrometer 14 may be configured to measure sample vibrations by emitting the probe light to a surface of the sample. In some embodiments, the laser Doppler vibrometer 14 may be connected with the processor. In some embodiments, an operating wavelength of the laser Doppler vibrometer may be preset, such as 633 nm.

In some embodiments, the probe light emitted from the laser Doppler vibrometer 14 may pass through the optical filter 13 to the surface of the sample.

In some embodiments, the laser Doppler vibrometer 14 may be connected with the processor according to a preset connection process.

The optical filter 13 may be configured to reduce an intensity and reflection of light. In some embodiments, the optical filter 13 may be placed directly in front of the laser Doppler vibrometer at a variety of preset angles. The preset angle may be preset, such as 45°.

The processor 7 may process data and/or information obtained and/or extracted from the energy detector 4, the photodetector 8, the scanning galvanometer 11, the laser Doppler vibrometer 14, and/or other storage devices. For example, the processor may obtain a numerical value of the beam energy of the laser detected by the energy detector. As another example, the processor may obtain an electrical signal from the photodetector. As a further example, the processor may record a position of each excitation point based on a preset scanning path and a position of the detection spot.

In some embodiments, the processor 7 may be a single server or a group of servers. The server group may be centralized or distributed. In some embodiments, the processor 7 may be local or remote. In some embodiments, the processor 7 may be implemented on a cloud platform. For example, a cloud platform may include a private cloud, a public cloud, a hybrid cloud, a community cloud, a distributed cloud, an on-premises cloud, a multi-tier cloud, or any combination thereof. In some embodiments, the processor 7 may be integrated on an end device. The end device may include a cell phone, a laptop, a desktop computer, or the like.

In some embodiments of the present disclosure, a detection device for laser spot welding micro-weld spot quality based on laser ultrasound may be applied to high-temperature and extreme environments and the detection of structural members with complex morphology, with fast scanning speed, intuitive and reliable detection results, and simple and easy-to-implement hardware devices.

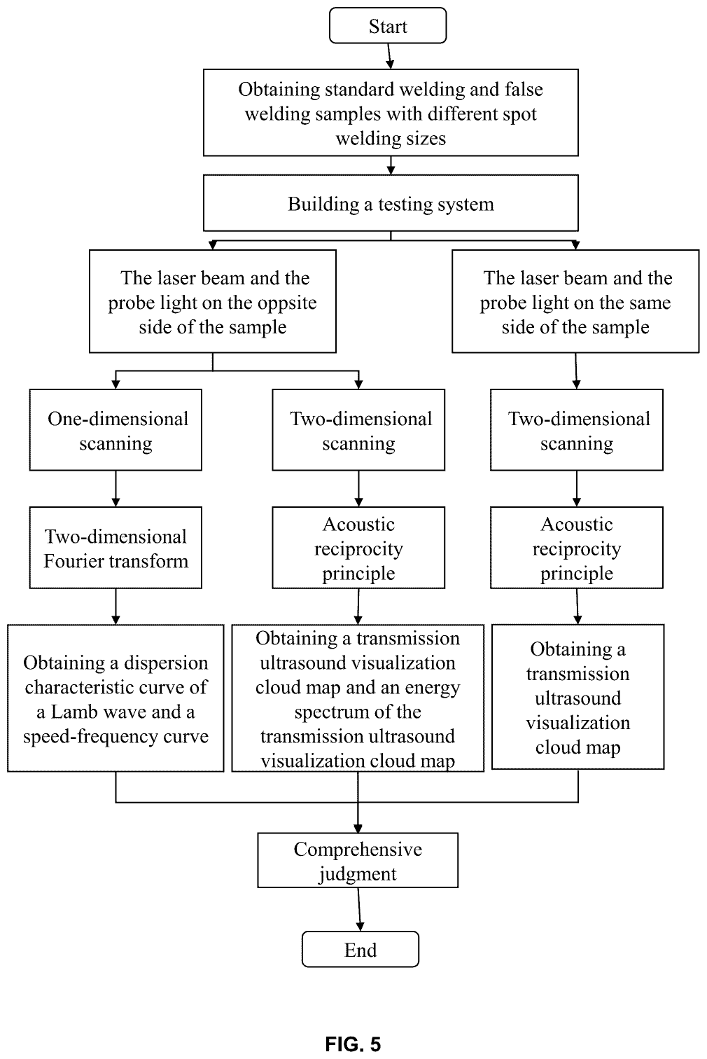

FIG. 5 is a flowchart illustrating an exemplary detection process of a detection device for laser spot welding micro-weld spot quality based on laser ultrasound according to some embodiments of the present disclosure. As shown in FIG. 5, the process includes the following operations:

In some embodiments, before implementing the detection process of a detection device for laser spot welding micro-weld spot quality based on laser ultrasound, the nanosecond pulsed laser and the laser Doppler vibrometer need to be active, the sample may be placed on the multi-axis displacement platform, and a position and angle of the sample may be adjusted to make the direction current (DC) signal of the Laser Doppler Vibrometer is maximized.

In some embodiments, a plurality of samples with different welding spot characteristics may be used when performing multiple detections.

In S1, a one-dimensional linear shape scanning and a two-dimensional rectangular shape scanning may be performed under a first condition.

In some embodiments, the processor may send a scanning parameter to a scanning galvanometer to control the scanning galvanometer to perform the one-dimensional linear shape scanning and the two-dimensional rectangular shape scanning under the first condition, and the scanning galvanometer may send a scanning result to the processor after the scanning galvanometer has finished the scanning.

In some embodiments, the processor may determine the scanning parameter in multiple ways. For example, the processor may obtain a scanning position and a preset scanning path input by a user, and determine the scanning position and the preset scanning path as the scanning parameter.

In some embodiments, the first condition may include the laser beam and the probe light on the opposite side of the sample.

In S2, the two-dimensional rectangular shape scanning may be performed under a second condition.

In some embodiments, after the processor may control the scanning galvanometer to perform the one-dimensional linear shape scanning and the two-dimensional rectangular shape scanning under the first condition, a position of the laser Doppler vibrometer needs to be moved to perform the two-dimensional rectangular shape scanning under the second condition.

In some embodiments, the processor may send the scanning parameter to the scanning galvanometer to control the scanning galvanometer to perform the two-dimensional rectangular shape scanning under the second condition, and the scanning galvanometer may send a scanning result to the processor after the two-dimensional rectangular shape scanning is completed.

In some embodiments, the second condition may include the laser beam and the probe light on the same side of the sample.

In S3, a scanning path of the scanning galvanometer may be controlled, positions of a plurality of excitation points and a position of a detection spot may be recorded, an acoustic field of an ultrasonic wave may be visualized, and a result of a visualization process may be obtained.

In some embodiments, the processor may record the positions of the plurality of excitation points and the position of the detection spot based on a preset scanning path, and visualize the acoustic field of the ultrasonic wave to obtain the visualization processing result.

The excitation point is a position on the preset scanning path of the surface of the sample where luminescence occurs due to the energy of the incident laser beam.

The detection spot refers to a spot presented by the probe light on the surface of the sample.

In some embodiments, the processor may visualize the acoustic field of the ultrasonic wave in a variety of ways based on positions of the plurality of excitation points and the position of the detection spot. For example, the processor may visualize the acoustic field of the ultrasonic wave based on a principle of acoustic reciprocity.

For example, the principle of acoustic reciprocity may be expressed by the following equation (a):

P_{A}(X_{Bi},ti)=P_{Bi}(X_{A},ti), Equation (a)

ti represents a moment of scanning to an ith excitation point, X_{A} represents a position of the detection spot, P_{A} represents an acoustic field at the position X_{A}, X_{Bi} represents a position of the ith excitation point, and P_{Bi} represents an acoustic field at the position X_{Bi}, and a range of i may include 1-n, and n is a count of excitation points.

In S4, an energy density spectrum of transmission may be determined.

In some embodiments, the processor may determine an energy density spectrum of transmission based on the acoustic field at the positions of the plurality of excitation points by a preset energy equation. For example, the preset energy equation may be represented by the following equation (b):

E=(P_{Bi})², Equation (b)

E represents energy at a sound field P_{Bi}, P_{Bi} denotes the sound field at the position X_{Bi}, and a range of i may include 1-n, n is a count of excitation points.

In S5, a dispersion characteristic curve of a Lamb wave may be generated based on a preset algorithm.

In some embodiments, the processor may generate the dispersion characteristic curve of the Lamb wave based on the preset algorithm. The preset algorithm may include a two-dimensional Fourier transform. For example, the preset algorithm is shown may be represented by the following equation (c):

U(f,k)=∫_{-∞}^{∞}∫_{-∞}^{∞}u(ti,X_{Bi})e^{-j(2πft-kX}^{_{Bi}}⁾dtdX_{Bi}, Equation (c)

j represents an imaginary number, f represents a frequency, k represents a wave number, ti represents a moment of scanning to an ith excitation point, X_{Bi} represents a position of the ith excitation point, a range of i includes 1-n, and n represents a count of excitation point, u(ti,X_{Bi}) represents a value of a spatial domain, and U(f,k) represents a value of a frequency domain.

In S6, a speed-frequency curve may be generated.

In some embodiments, the processor may generate a speed-frequency curve based on a frequency differentiation and a wavenumber differentiation. In some embodiments, a horizontal and vertical coordinate of the speed-frequency curve includes multiple forms. For example, a horizontal coordinate of the speed-frequency curve may be frequency and a vertical coordinate may be velocity.

In S7, welding quality of laser spot welding based on the visualization processing result may be determined, the dispersion characteristic curve of a Lamb wave and the speed-frequency curve.

In some embodiments, the processor may determine welding quality of the laser spot weld in a variety of ways based on the visualization processing result, the dispersion characteristic curve of the Lamb wave, and the speed-frequency curve. For example, the processor may select, based on the visualization processing result, the dispersion characteristic curve of the Lamb waves, and the speed-frequency curve, a testing process in a history database that matches the visualization processing result, the dispersion characteristic curve of the Lamb waves, and the speed-frequency curve, and determine welding quality corresponding to the testing process as welding quality of the laser spot welding.

The history database may be preconfigured based on historical data, including multiple testing processes, the visualization processing results of the testing processes, the dispersion characteristic curve of the Lamb wave, and the speed-frequency curve, and the welding quality.

In some embodiments of the present disclosure, the detection process of the detection device for laser spot welding micro-weld spot quality based on laser ultrasound may be convenient and efficient, and the detection process is a completely non-contact laser spot welding micro-weld spot non-destructive detection.

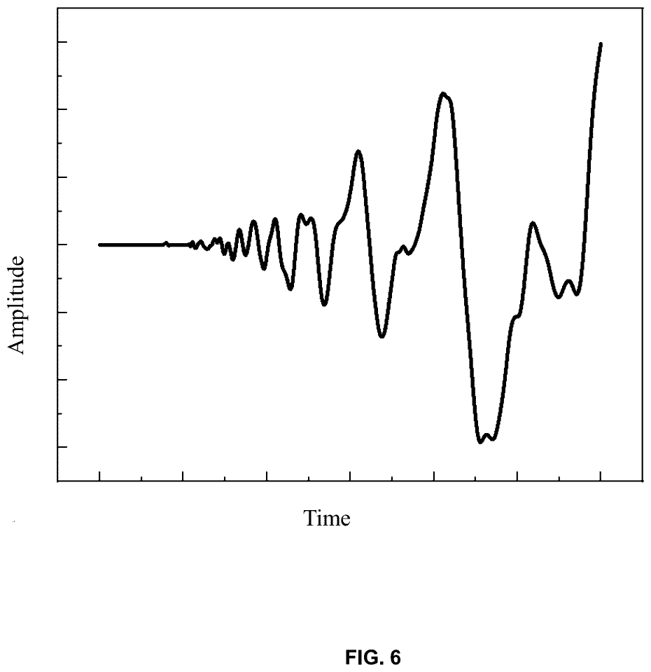

FIG. 6 is a schematic diagram illustrating an exemplary Lamb wave according to some embodiments of the present disclosure.

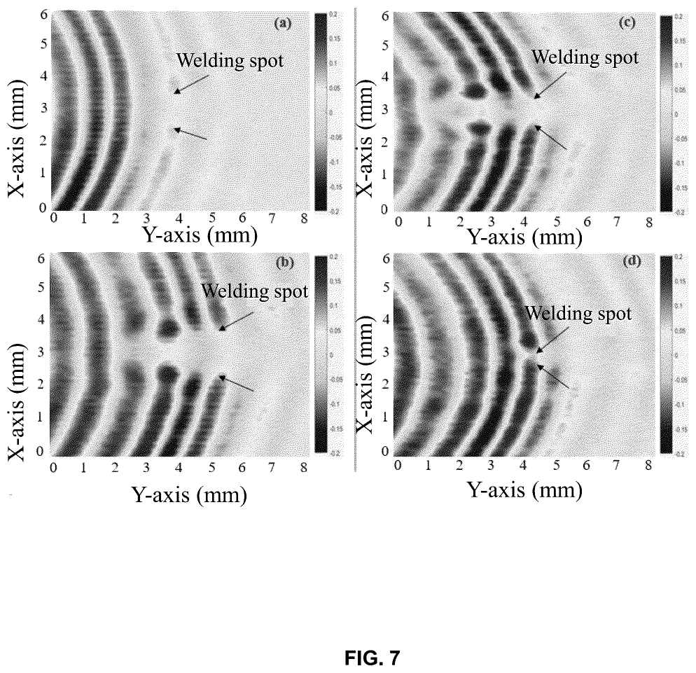

FIG. 7 is a schematic diagram illustrating an exemplary visualization ultrasonic field map according to some embodiments of the present disclosure, wherein (a) and (b) are schematic diagrams illustrating 1.2 mm standard welding at different moments, and (c) and (d) are schematic diagrams illustrating a 0.4 mm standard welding and a 0.4 mm false welding at the same moment.

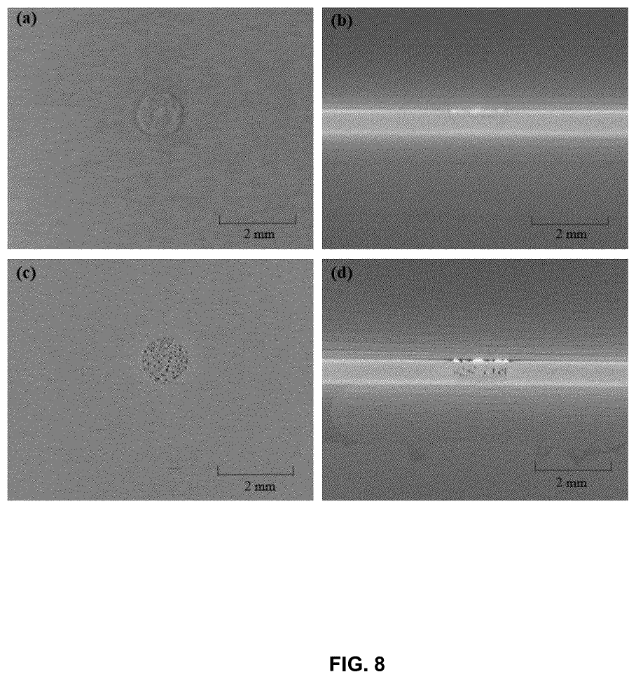

FIG. 8 is a schematic diagram illustrating an exemplary industrial computed tomography (CT) testing result according to some embodiments of the present disclosure; wherein (a) is a schematic diagram illustrating a top view of a 1.2 mm standard welding diagram, (b) is a schematic diagram illustrating a cross-sectional view of a 1.2 mm standard welding diagram, (c) is a schematic diagram illustrating a top view of a 1.2 mm false welding diagram, and (d) is a schematic diagram illustrating a cross-sectional view of a 1.2 mm false welding diagram. The following embodiments may be understood by referring to FIGS. 6, 7, and 8, but the accompanying drawings are only a schematic representation of some of the embodiments and do not constitute a limitation on the embodiments.

In some embodiments, as shown in FIG. 1, the detection device for laser spot welding micro-weld spot quality based on laser ultrasound may include: an ultrasound signal excitation device, an ultrasound signal detection device, and a signal processing unit. The ultrasonic signal excitation device may include a nanosecond pulsed laser 1, and a wavelength of the nanosecond pulsed laser 1 may be 532 nm or 1064 nm, and a pulse width may be 6 to 12 ns, preferably 8 ns. After the nanosecond pulsed laser 11 may emit a pulsed laser passing through the one half-wave plate 2, the polarizing beam splitter 3, and a certain proportion of the laser beam 15 may reach the energy detector 4, and the beam energy of the separated pulsed laser beam 15 through the head 6 of the energy detector. A portion of the laser beam 15 split by the beam splitter mirror 5 may arrive at the photodetector 8 as a trigger signal, and another portion of the laser beam 15 split by the beam splitter mirror 5 may pass through the light reflecting mirror 9, the aperture 10, and arrive at the high-speed scanning galvanometer 11 (with a maximum resonance frequency of 10 KHz) to focus as a point source and excite an ultrasonic wave on the surface of the sample of the multi-axis displacement platform 12 according to the preset scanning path. The ultrasonic signal detection device may include an optical filter 13 with 532 nm high reflectivity and 633 nm high transmittance, and a laser Doppler vibrometer 14 with a 633 nm operating wavelength, the optical filter 13 may be placed at a 45° angle in front of the laser Doppler vibrometer 14. The signal processing unit may include a processor 7. The head 6 of the energy detector, the photodetector 8, and the laser Doppler vibrometer 14 may transmit signals to the processor 7 through data cables, respectively.

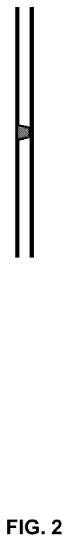

In some embodiments, as shown in FIG. 2, the sample is made by welding two pieces of 304 stainless steel plate with the thickness of 0.2 mm together. The welding spot characteristics may be a standard welding and a false welding with diameters of 1.2 mm and 0.4 mm, respectively, i.e., (a) 1.2 mm standard welding, (b) 1.2 mm false welding, (c) 0.4 mm standard welding, and (d) 0.4 mm false welding.

In some embodiments, the preset scanning path may be a one-dimensional linear shape scanning and a two-dimensional rectangular shape scanning. The laser beam 15 is emitted from nanosecond pulsed laser 1 along the scanning galvanometer 11, and the probe light is emitted along the optical filter 13. In some embodiments, as shown in FIG. 3, the one-dimensional linear shape scanning is performed by the following operations: the laser beam 15 and the probe light 16 are on the opposite side of the sample, the laser beam 15 and the probe light 16 are in the same perpendicular direction, the probe light 16 is located directly below the laser beam 15, and the center of the scanning path of the laser beam 15 is the position of the welding spot. The two-dimensional rectangular shape scanning is performed by the following operations: the laser beam 15 and the probe light 16 are on the opposite side and the same side of the sample, respectively. In some embodiments, as shown in FIG. 4, when the laser beam 15 and the probe light 16 are on the same side of the sample, the probe light 16 is located directly below the rectangular scanning path and the center of the scanning path is at the position of the welding spot; when the laser beam 15 and the probe light 16 are on the opposite side of the sample, the probe light 16 is located at a backside position of the welding spot and the center of the scanning path is the position of the welding spot.

In some embodiments, as shown in FIG. 5, the detection method of the detection device for laser spot welding micro-weld spot quality based on laser ultrasound may include the following operations:

In S1, a nanosecond pulsed laser 1 and a laser Doppler vibrometer 14 may be turned on, a sample to be detected may be placed on a multi-axis displacement platform 12, and a position and angle of the sample may be adjusted to maximize a direct current (DC) signal of the laser Doppler vibrometer 14;

In S2, a scanning parameter may be set, a scanning position and path of the scanning galvanometer 11 may be controlled by a processor 7, and a one-dimensional linear shape scanning and a two-dimensional rectangular shape scanning may be performed, data may be stored in the processor 7, and then a position of the laser Doppler vibrometer 14 may be moved so that the laser beam 15 and the probe light 16 may perform the two-dimensional rectangular shape scanning on the same side of the sample, and data may be stored in the processor 7.

In S3, the scanning path of the scanning galvanometer 11 may be controlled by the processor 7, a position X_{B} of each excitation point and a spot position X_{A} of the probe light 16 may be recorded, and an acoustic field of an ultrasonic wave may be visualized according to a principle of acoustic reciprocity P_{A}(X_{Bi},ti)=P_{Bi}(X_{A},ti), wherein ti represents a moment of scanning to the ith excitation point, X_{A} represents a position of a detection spot, P_{A} represents an acoustic field at the position X_{A}, X_{Bi} represents a position of the ith excitation point, and P_{Bi} represents an acoustic field at the position X_{Bi}, and a range of i may include 1-n, and n is a count of excitation points.

In S4, the processor may calculate the energy density spectrum of transmission based on an equation E=(P_{Bi})²;

In S5, As shown in FIG. 6, the processor may draw the dispersion characteristic curve of the Lamb wave according to the two-dimensional Fourier transform, which may be expressed by the following equation (c):

U(f,k)=∫_{-∞}^{∞}∫_{-∞}^{∞}u(ti,X_{Bi})e^{-j(2πft-kX}^{_{Bi}}⁾dtdX_{Bi}, Equation (c)

j represents an imaginary number, f represents a frequency, k represents a wave number, ti represents a moment of scanning to an ith excitation point, X_{Bi} represents a position of the ith excitation point, a range of i includes 1-n, and n represents a count of excitation point, u(ti,X_{Bi}) represents a value of a spatial domain, and U(f,k) represents a value of a frequency domain.

In S6, the processor may draw a speed-frequency curve based on a frequency differentiation and a wavenumber differentiation;

In S7, the processor may determine welding quality of the laser spot welding by analyzing the visualization processing result, the dispersion characteristic curve of the Lamb wave, and the speed-frequency curve.

In some embodiments, as shown in FIG. 7, a 1.2 mm standard welding spot has greater resistance to acoustic wave propagation than 0.4 mm standard welding spot. Additionally, a 0.4 mm standard welding spot has greater resistance to acoustic wave propagation than a 0.4 mm false welding spot.

In some embodiments, as shown in FIG. 8, a 1.2 mm standard welding spot has a dense interior with no air holes, while a 1.2 mm false welding spot has a loose interior with some defects such as air holes.

In addition, certain features, structures, or characteristics of one or more embodiments of the present disclosure may be suitably combined.

Some embodiments use numbers to describe the number of components, attributes, and it should be understood that such numbers used in the description of the embodiments are modified in some examples by the modifiers “approximately” or “generally” is used in some examples. Unless otherwise noted, the terms about,” “approximate,” or “approximately” indicates that a ±20% variation in the stated number is allowed. Correspondingly, in some embodiments, the numerical parameters used in the specification and claims are approximations, which may change depending on the desired characteristics of individual embodiments. In some embodiments, the numerical parameters should take into account the specified number of valid digits and employ general place-keeping. While the numerical domains and parameters used to confirm the breadth of their ranges in some embodiments of the present disclosure are approximations, in specific embodiments such values are set to be as precise as possible within a feasible range.

In the event of any inconsistency or conflict between the descriptions, definitions, and/or use of terms in the materials cited in the present disclosure and those described in the present disclosure, the descriptions, definitions, and/or use of terms in the present disclosure shall prevail.

What is claimed is:

1. A detection device for laser spot welding micro-weld spot quality based on laser ultrasound, comprising:
a nanosecond pulsed laser configured to emit a laser, wherein the laser passes through a half-wave plate to reach a polarizing beam splitter;
the polarizing beam splitter configured to perform a laser beam splitting, wherein a laser beam after performing the laser beam splitting by the polarizing beam splitter enters an energy detector and a beam splitter mirror, respectively, and the energy detector is connected with a processor by a head of the energy detector;
the beam splitter mirror configured to perform the laser beam splitting on the laser entering the beam splitter mirror, wherein the laser beam after performing the laser beam splitting enters a photodetector and a light reflecting mirror, respectively, the photodetector is connected with the processor, and the light reflecting mirror is configured to change a direction of the laser beam;
an aperture configured for the laser beam passing through the light reflecting mirror, the laser beam passing through a scanning galvanometer to reach a multi-axis displacement platform; and
the multi-axis displacement platform configured to place and/or move a sample;
wherein the multi-axis displacement platform, an optical filter, and a laser Doppler vibrometer are deployed in a same line, and the laser Doppler vibrometer is connected with the processor.

2. A detection device for laser spot welding micro-weld spot quality based on laser ultrasound of claim 1, wherein the scanning galvanometer is configured to focus the laser beam as a point source and excite an ultrasonic wave on a surface of the sample according to a preset scanning path, the sample is placed on the multi-axis displacement platform.

3. The detection device for laser spot welding micro-weld spot quality based on laser ultrasound of claim 2, wherein the preset scanning path includes a one-dimensional linear shape scanning and/or a two-dimensional rectangular shape scanning.

4. A detection device for laser spot welding micro-weld spot quality based on laser ultrasound of claim 3, wherein when the preset scanning path is the one-dimensional linear shape scanning, the laser beam and a probe light are on an opposite side of the sample, and the probe light is emitted by the laser Doppler vibrometer.

5. A detection device for laser spot welding micro-weld spot quality based on laser ultrasound of claim 4, wherein when the preset scanning path is the one-dimensional linear shape scanning and the laser beam and the probe light are on the opposite side of the sample, the laser beam and the probe light are located in a same perpendicular direction, the probe light is located below the laser beam, and a center of a scanning path of the laser beam is a position of a welding spot.

6. A detection device for laser spot welding micro-weld spot quality based on laser ultrasound of claim 3, wherein when the preset scanning path is the two-dimensional rectangular shape scanning, the laser beam and a probe light are on an opposite side or a same side of the sample.

7. The detection device for laser spot welding micro-weld spot quality based on laser ultrasound of claim 6, wherein when the preset scanning path is the two-dimensional rectangular shape scanning and the laser beam and the probe light are on the opposite side of the sample, a position of the probe light is a backside position of a welding spot, and a center of a scanning path of the laser beam is a position of a welding spot.

8. A detection device for laser spot welding micro-weld spot quality based on laser ultrasound of claim 6, wherein when the preset scanning path is the two-dimensional rectangular shape scanning and the laser and the probe light are on a same side of the sample, the probe light is located directly below the preset scanning path, and a center of a scanning path of the laser is a position of a welding spot.

9. A detection device for laser spot welding micro-weld spot quality based on laser ultrasound of claim 1, wherein a wavelength range of the nanosecond pulsed laser includes 532-1064 nm, and a pulse width range includes 6-12 ns.

10. A detection method for laser spot welding micro-weld spot quality based on laser ultrasound, wherein the method is executed by a processor, comprising:
performing a one-dimensional linear shape scanning and a two-dimensional rectangular shape scanning under a first condition, wherein the first condition includes a laser beam and a probe light on an opposite side of a sample;
performing the two-dimensional rectangular shape scanning under a second condition, wherein the second condition includes the laser beam and the probe light on a same side of the sample;
controlling a scanning path of the scanning galvanometer by the processor, recording positions of a plurality of excitation points and a position of a detection spot, visualizing an acoustic field of an ultrasonic wave, and obtaining a result of a visualization process;
determining an energy density spectrum of transmission;
generating a dispersion characteristic curve of a Lamb wave based on a preset algorithm, wherein the preset algorithm includes a two-dimensional Fourier transform, and an expression of the preset algorithm is shown in formula(c):
U(f,k)=∫_{-∞}^{∞}∫_{-∞}^{∞}u(ti,X_{Bi})e^{-j(2πft-kX}^{_{Bi}}⁾dtdX_{Bi} (c)
wherein j represents an imaginary number, f represents a frequency, k represents a wave number, ti represents a moment of scanning to an ith excitation point, X_{Bi} represents a position of the ith excitation point, a range of i includes 1-n, and n represents a count of excitation point, u(ti,X_{Bi}) represents a value of a spatial domain, and U(f,k) represents a value of a frequency domain;
generating a speed-frequency curve; and
determining welding quality of laser spot welding based on the visualization processing result, the dispersion characteristic curve of the Lamb wave, and the speed-frequency curve.
